(19) United States
(12) Patent Application Publication
(10) Pub. No.: US 2015/0198739 A1
(43) Pub. Date: Jul. 16, 2015

(54) INSOLATION CALCULATING DEVICE, ROUTE PROPOSING DEVICE, AND INSOLATION CALCULATING METHOD

(71) Applicant: KABUSHIKI KAISHA TOSHIBA, Minato-ku (JP)

(72) Inventors: Yusuke ENDOH, Kawasaki (JP); Hiromasa SHIN, Yokohama (JP); Mikito IWAMASA, Shinagawa (JP); Kohei MARUCHI, Yokohama (JP); Masahiro SAKAI, Kawasaki (JP)

(73) Assignee: KABUSHIKI KAISHA TOSHIBA, Minato-ku (JP)

(21) Appl. No.: 14/595,520

(22) Filed: Jan. 13, 2015

(30) Foreign Application Priority Data
Jan. 14, 2014 (JP) 2014-004108

(51) Int. Cl. G01W 1/12

(52) U.S. Cl. CPC G01W 1/12

(57) ABSTRACT

An insolation calculating device has a 3D model acquisition module to acquire a 3D model of an area around a target location to calculate insolation, a routing information acquisition module to acquire routing information about the area around the location, a main routing information extractor to acquire main routing information including a plurality of representative points from the routing information acquired by the routing information acquisition module, a sky diagram generator to generate a sky diagram at each of the representative points, the sky diagram being generated as two-dimensional image data corresponding to a shot image of the whole sky, a representative point insolation calculator to calculate representative point insolation showing insolation at each of the representative points, and a route insolation calculator to calculate insolation of each route connecting two adjacent representative points in the representative points.

### CROSS REFERENCE TO RELATED APPLICATIONS

This application is based upon and claims the benefit of priority from the prior Japanese Patent Application No. 2014-4108, filed on Jan. 14, 2014, the entire contents of which are incorporated herein by reference.

### FIELD

Embodiments of the present invention relate to an insolation calculating device, a route proposing device, and to an insolation calculating method.

### BACKGROUND

Techniques for calculating insolation at a predetermined point have been proposed. For example, there is a technique in which insolation is calculated based on a shady area identified by specifying the position of the sun based on latitude, longitude, time, season, etc., and acquiring a 3D model around that point.

This technique requires specifying the position of the sun and acquiring the 3D model with respect to each target point to calculate insolation, which means that an enormous amount of calculation is required to increase calculation accuracy.

### BRIEF DESCRIPTION OF THE DRAWINGS

FIG. 1 is a schematic block diagram of an insolation calculating device 1 according to a first embodiment of the present invention.

FIG. 2 is a diagram showing 3D models and routing information in an example.

FIG. 3 is a diagram showing an example of main routing information extracted by a main routing information extractor 4 from the routing information of FIG. 2.

FIG. 4 is a schematic block diagram of a route proposing device 20 performing the processing operation of the insolation calculating device 1 according to a second embodiment.

FIG. 5 is a diagram showing an example of calculated insolation of each route extracted by the main routing information extractor 4.

FIG. 6 is a diagram showing an example of an optimum route candidate.

FIG. 7A is a flow chart showing an example of the steps performed to generate a cost function, and FIG. 7B is a flow chart showing an example of the steps performed to search an optimum route candidate.

FIG. 8 is a diagram showing an example of clustering.

FIG. 9 is a diagram showing an example of representative points narrowed down by the clustering.

### DETAILED DESCRIPTION

According to one embodiment, an insolation calculating device has a 3D model acquisition module to acquire a 3D model of an area around a target location to calculate insolation, a routing information acquisition module to acquire routing information about the area around the location, a main routing information extractor to acquire main routing information including a plurality of representative points from the routing information acquired by the routing information acquisition module, a sky diagram generator to generate a sky diagram at each of the representative points, the sky diagram being generated as two-dimensional image data corresponding to a shot image of the whole sky, a representative point insolation calculator to calculate representative point insolation showing insolation at each of the representative points, based on the sky diagram at the representative point, and a route insolation calculator to calculate insolation of each route connecting two adjacent representative points in the representative points, based on the representative point insolation at each of the representative points.

Hereinafter, embodiments of the present invention will be described with reference to the accompanying drawings.

### First Embodiment

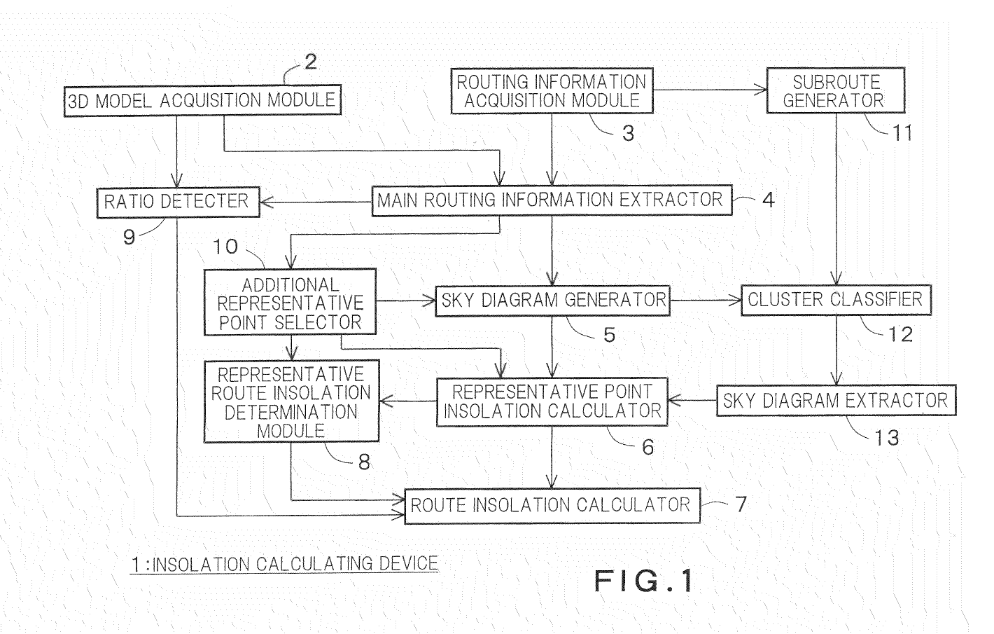

FIG. 1 is a schematic block diagram of an insolation calculating device 1 according to a first embodiment of the present invention. The insolation calculating device 1 of FIG. 1 has a 3D model acquisition module 2, a routing information acquisition module 3, a main routing information extractor 4, a sky diagram generator 5, a representative point insolation calculator 6, and a route insolation calculator 7.

The 3D model acquisition module 2 acquires a 3D model of an area around a target location to calculate insolation. The area may mean a predetermined area having the target location to calculate insolation at the center thereof or an area which can be arbitrarily set. As a concrete example, the area means an area having a predetermined radius from the target location serving as the center thereof. The 3D model is three-dimensional image data of the area around the target location to calculate insolation. A concrete method for acquiring the 3D model is not questioned. For example, the 3D model acquisition module 2 may access a server etc. to acquire a 3D model of the area around a point included in predicted insolation information, or may use any tool to generate a 3D model.

The routing information acquisition module 3 accesses, e.g., a routing information database (not shown) to acquire routing information about the area around the target location to calculate insolation. The routing information is information for identifying each route connecting representative points. More concretely, the routing information includes information about the location and length of each route, types of the representative points at both ends of each route, etc.

The main routing information extractor 4 acquires main routing information including a plurality of representative points from the routing information acquired by the routing information acquisition module 3. Here, the main routing information is routing information on which insolation should be calculated, and may include information about representative points. The main routing information extractor 4 omits such routing information as less important to calculate insolation, in order to reduce the volume of routing information, and to increase the speed of calculating insolation. Judgment on whether the routing information is main routing information or not depends on how to determine the representative points. For example, when only intersections are regarded as the representative points, all representative points may be treated as the main routing information. Further, when representative points are provided at predetermined intervals on the route, it may be possible to select only a part of the representative points as the main routing information. When omitting a less important representative point from the original routing information, a point on the route connected to the omitted representative point may possibly disappear. In this case, this route is eliminated while providing a new route connecting the main representative points. As mentioned later, when a new representative point is provided on a certain route, the main routing information extractor 4 extracts information about the route connected to the new representative point.

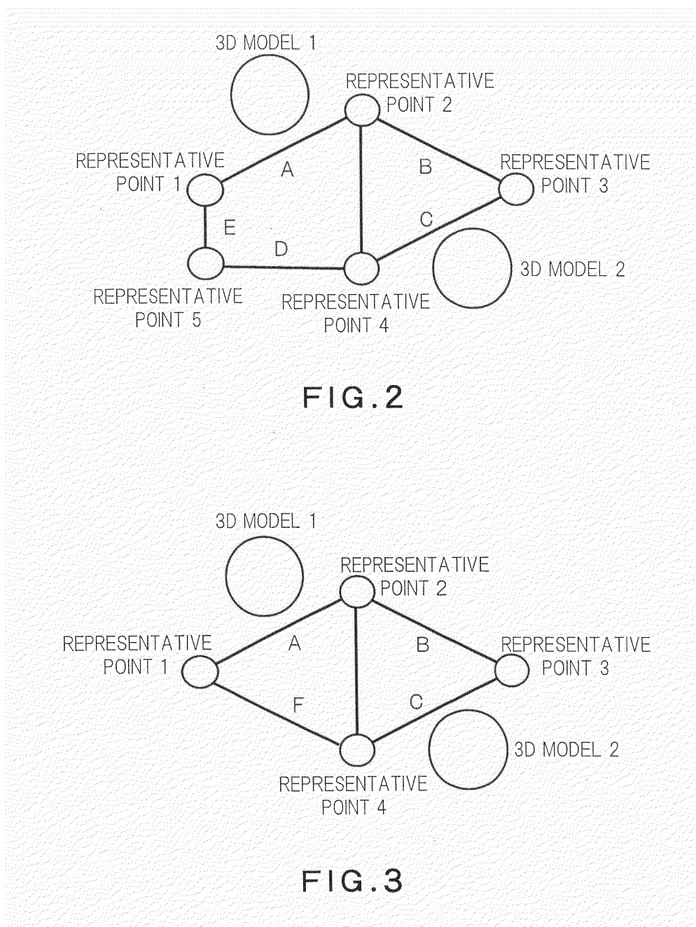

FIG. 2 is a diagram showing 3D models and routing information in an example. As shown in this figure, the routing information includes routes each connecting two adjacent representative points. In the example shown in FIG. 2, six routes A to E, five representative points 1 to 5, and two 3D models 1 and 2 are provided.

When the 3D models 1 and 2 are provided beside the routes A and C respectively as shown in this figure, the routes A and C are shaded by the 3D models 1 and 2 respectively. Note that the existence/nonexistence of the shade and the size of the shade change depending on hours and seasons. Here, the representative point means an intersection of a plurality of routes, a point on each route at which insolation changes suddenly, etc.

FIG. 3 is a diagram showing an example of main routing information extracted by the main routing information extractor 4 from the routing information of FIG. 2. In the example of FIG. 3, the representative point 5 of FIG. 2 is eliminated, and two representative points 1 and 4 each adjacent to the representative point 5 are connected to provide a new route F as the main routing information.

The sky diagram generator 5 generates a sky diagram at each of the representative points, the sky diagram being generated as two-dimensional image data corresponding to a shot image of the whole sky. The sky diagram is generated by imaging the whole sky including the 3D model and the appearance of sunlight irradiated from the position of the sun at the time of calculating insolation at each representative point. The sky diagram is two-dimensional image data consisting of a plurality of pixels.

The representative point insolation calculator 6 calculates representative point insolation showing insolation at each of the representative points, based on the sky diagram at the representative point. More concretely, the representative point insolation calculator 6 calculates solar insolation with respect to each pixel of the sky diagram corresponding to each representative point, considering the direction of the sun and obstacles to solar radiation, and accumulates the insolation concerning every pixel, thereby calculating the representative point insolation.

The route insolation calculator 7 calculates the insolation of each route connecting two adjacent representative points in the representative points, based on the representative point insolation at each of the representative points. As shown below, the route insolation calculator 7 detects the ratio of the sun to the shade with respect to each route connecting two arbitrary adjacent representative points included in the representative points, and divides the representative point insolation proportionally based on the ratio, thereby calculating the insolation of each route.

In the present embodiment, the insolation calculating device 1 of FIG. 1 has a route representative insolation determination module 8 and a ratio detector 9, in order that the route insolation calculator 7 calculates the insolation of each route with high accuracy.

The route representative insolation determination module 8 calculates representative insolation in the sun and representative insolation in the shade on each route connecting two adjacent representative points in the representative points, based on the representative point insolation at each of the two representative points on the route.

More concretely, the route representative insolation determination module 8 calculates the representative insolation in the sun and the representative insolation in the shade on the corresponding route, depending on whether both of the two adjacent representative points are in the sun or in the shade, or one is in the sun and the other is in the shade.

The ratio detector 9 detects a ratio of the sun to the shade on each route connecting two adjacent representative points in the representative points. More specifically, the ratio detector 9 calculates the direction of the sun from the current time, and detects a shady region on the target route based on the 3D model. This detection can be achieved by using shadow map method, shadow volume method, etc., which are rendering techniques generally used in the field of computer graphics based on 3D models.

When the insolation calculating device 1 of FIG. 1 has the route representative insolation determination module 8 and ratio detector 9, the route insolation calculator 7 calculates the insolation of each route connecting two adjacent representative points in the representative points by weighting the representative insolation in the sun and the representative insolation in the shade corresponding to the route, based on the corresponding ratio.

Further, the insolation calculating device 1 of FIG. 1 may have an additional representative point selector 10. The additional representative point selector 10 makes it possible to calculate insolation with higher accuracy. The additional representative point selector 10 selects, when both of two adjacent representative points in the representative points are in the shade, a sunny spot on the route connecting the two representative points, as a new representative point. In this case, the sky diagram generator 5 generates a sky diagram at the new representative point. Further, the representative point insolation calculator 6 calculates representative point insolation corresponding to the new representative point. Furthermore, the route representative insolation determination module 8 determines the representative point insolation corresponding to the new representative point as representative insolation in the shade on this route.

When the additional representative point selector 10 is not provided, if two representative points at both ends of a certain route are both in the shade, it is impossible to grasp representative insolation in the sun on that route. On the other hand, when the additional representative point selector 10 is provided, even if two representative points at both ends of a certain route are both in the shade, representative insolation in the sun can be set by searching a sunny location on that route. Thus, the additional representative point selector 10 makes it possible to calculate insolation with higher accuracy, which nevertheless lengthens calculation time as requiring a process for searching a sunny location on the route.

Further, the insolation calculating device 1 of FIG. 1 may have a subroute generator 11, a cluster classifier 12, and a sky diagram extractor 13, which makes it possible to calculate insolation with higher accuracy.

The subroute generator 11 generates a plurality of subroutes by dividing each route included in the routing information acquired by the routing information acquisition module 3 at predetermined intervals. The cluster classifier 12 collects sky diagrams which are similar to each other in the sky diagrams generated by the sky diagram generator 5 corresponding to dividing points of the subroutes, to merge the collected sky diagrams into one cluster. The sky diagram extractor 13 extracts a characteristic sky diagram to calculate the insolation, from the sky diagrams belonging to each cluster classified by the cluster classifier 12. In this case, the representative point insolation calculator 6 calculates the representative point insolation at a representative point corresponding to the sky diagram extracted by the sky diagram extractor 13.

For example, when only intersections are treated as representative points, the interval between the representative points becomes long in the area having a small number of intersections, which deteriorates the accuracy of calculation of insolation. However, when setting representative points at regular intervals on the route, the number of representative points becomes too large, which may possibly require enormous time to calculate insolation. On the other hand, when the cluster classifier 12 is provided as stated above, a minimum number of essential representative points can be automatically arranged at appropriate locations, which makes it possible to calculate insolation with a smaller amount of calculation and with high accuracy.

As stated above, in the first embodiment, the insolation of each route can be calculated simply and with high accuracy by generating a sky diagram at each representative point, calculating representative point insolation at each representative point based on the generated sky diagram, and calculating insolation of the route connecting two adjacent representative points based on the representative point insolation.

Further, the insolation of each route can be calculated with high accuracy by detecting the ratio of the sun to the shade on each route connecting two adjacent representative points.

Furthermore, the representative insolation in the sun/shade can be calculated with higher accuracy by calculating the representative insolation in the sun and the representative insolation in the shade on the corresponding route, depending on whether both of the two adjacent representative points are in the sun or in the shade, or one is in the sun and the other is in the shade.

### Second Embodiment

A second embodiment to be explained below is obtained by further concretizing the first embodiment.

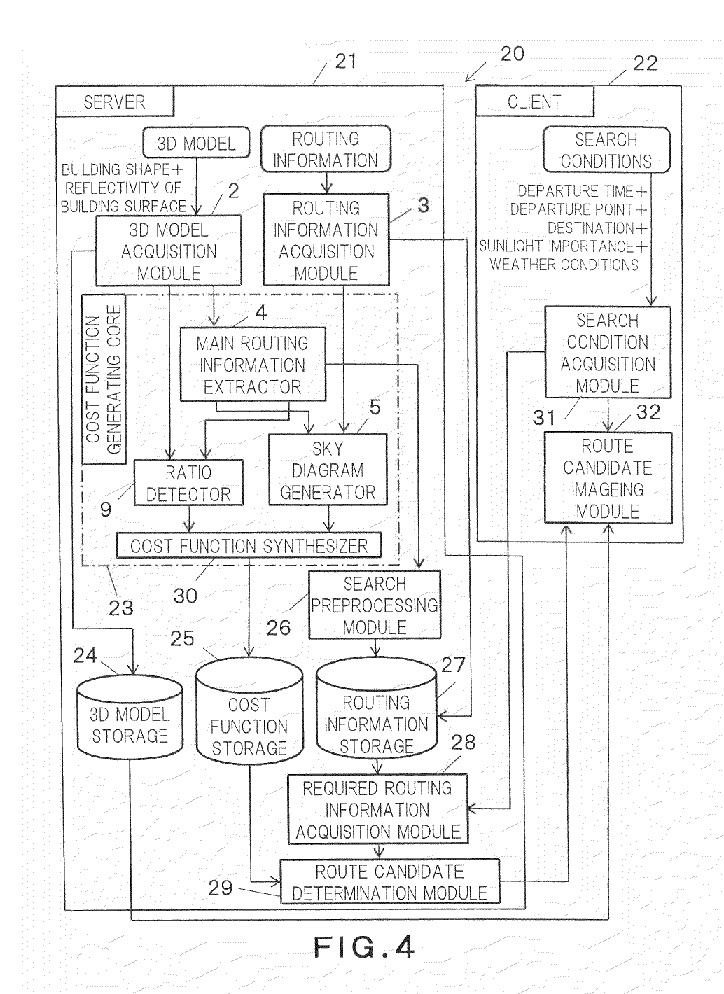

FIG. 4 is a schematic block diagram of a route proposing device 20 performing the processing operation of the insolation calculating device 1 according to the second embodiment.

The route proposing device 20 of FIG. 4 has a server device 21 and a client device 22. The server device 21 and client device 22 may directly communicate through wire or wireless communication, or may communicate through a network (not shown). Further, the server device 21 and client device 22 may be provided in the same computer machine. In this case, the server device 21 and client device 22 communicates within the machine.

The server device 21 has the 3D model acquisition module 2, the routing information acquisition module 3, a cost function generating core unit 23, a 3D model storage 24, a cost function storage (insolation storage) 25, a search preprocessing module 26, a routing information storage 27, a required routing information acquisition module 28, and a route candidate determination module 29. In FIG. 4, the same names are given to the components which are included in the server device 21 and client device 22 and function similarly to the components in the insolation calculating device 1 of FIG. 1. Therefore, hereinafter, explanation will be given on the processing units which are not included in the insolation calculating device 1 of FIG. 1.

The cost function generating core unit 23 generates a cost function for calculating insolation at each certain time, based on the 3D model acquired by the 3D model acquisition module 2 and the routing information acquired by the routing information acquisition module 3.

The cost function generating core unit 23 has the main routing information extractor 4, the ratio detector 9, the sky diagram generator 5, and a cost function synthesizer (insolation pre-calculating module) 30.

The cost function synthesizer 30 calculates the insolation of each route based on the sky diagram at each representative point and on the ratio of the shade on each route. When calculating the insolation of each route, the representative insolation in the sun and the representative insolation in the shade are determined in accordance with the following rules.

1) When both of two adjacent representative points are in the sun, the average insolation calculated based on the sky diagrams at these two representative points is defined as the representative insolation in the sun on this route.

2) When one of two adjacent representative points is in the sun and the other is in the shade, the insolation calculated based on the sky diagram at the representative point in the sun is defined as the representative insolation in the sun on this route.

3) When both of two adjacent representative points are in the shade, the standard insolation in the sun in the area including these representative points is defined as the representative insolation in the sun on this route.

4) When both of two adjacent representative points are in the shade, the average insolation calculated based on the sky diagrams at these two representative points is defined as the representative insolation in the shade on this route.

5) When one of two adjacent representative points is in the shade and the other is in the sun, the insolation calculated based on the sky diagram at the representative point in the shade is defined as the representative insolation in the shade on this route.

6) When both of two adjacent representative points are in the sun, the standard insolation in the shade in the area including these representative points is defined as the representative insolation in the shade on this route.

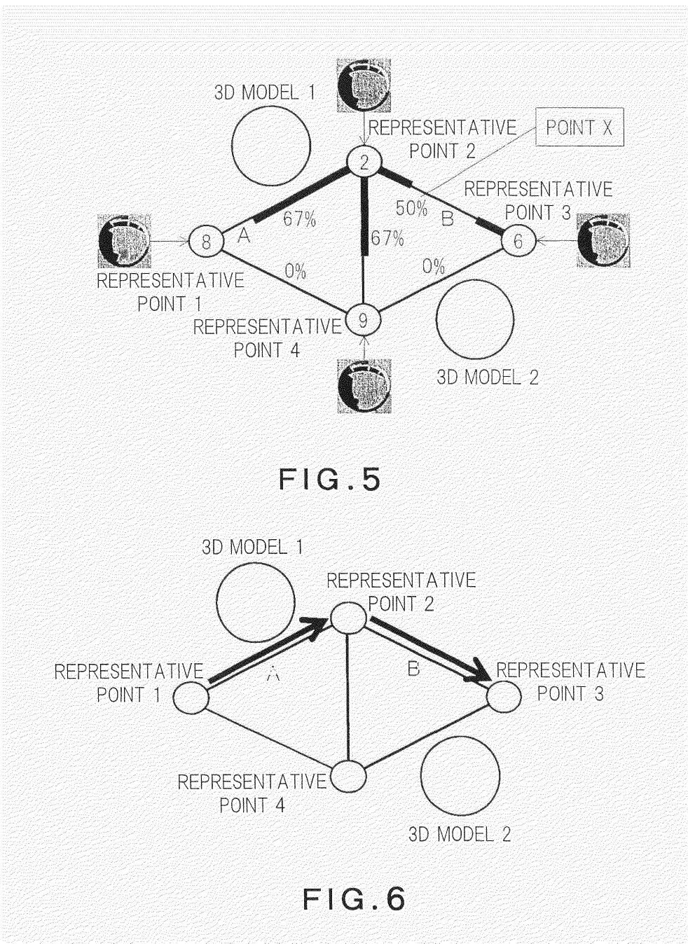

FIG. 5 is a diagram showing an example of calculated insolation of each route extracted by the main routing information extractor 4. In the example of FIG. 5, representative points 1 and 4 are in the sun, and representative points 2 and 3 are in the shade. It is defined that the insolation at the representative point 1 (representative point insolation) is 8, the representative point insolation at the representative point 2 is 2, the representative point insolation at the representative point 3 is 6, and the representative point insolation at the representative point 4 is 9.

With respect to a route A connecting the representative points 1 and 2, the representative point 1 is in the sun and the representative point 2 is in the shade, which means that the representative insolation in the sun is 8 and the representative insolation in the shade is 2, according to the above rules 1) to 6). With respect to a route B connecting the representative points 2 and 3, both of the representative points 2 and 3 are in the shade, which means that the representative insolation in the sun is 10 corresponding to the standard insolation in the sun in this area and the representative insolation in the shade is 4 corresponding to the average of the insolation at the representative point 2 and the insolation at the representative point 3.

Next, the cost function synthesizer 30 weights the representative insolation in the sun and the representative insolation in the shade on each route to calculate an average insolation depending on the ratio of the shade on each route.

In FIG. 5, the ratio of the shade on each route is expressed with a thick line. For example, with respect to the route A connecting the representative points 1 and 2, the ratio of the shade is 67%, which means that the ratio of the shade is twice that of the sun. Thus, the insolation of the route A is calculated as follows: (8×1+2×2)/3=4. With respect to the route B connecting the representative points 2 and 3, the ratio of the shade and the ratio of the sun are equal to each other, and thus the insolation of the route B is calculated as follows: (10+4)/2=7. Similar calculation is performed also on the other routes.

The cost function synthesizer 30 weights the representative insolation in the sun and the representative insolation in the shade on each route at each different time to calculate an average insolation of each route depending on the ratio of the shade on each route, and stores the calculated insolation of each route in the cost function storage 25 as a cost function.

The search preprocessing module 26 performs, if needed, a preprocess on the main routing information extracted by the main routing information extractor 4. It is assumed that this preprocess is performed depending on a request from the client device 22 to add additional information to be displayed around an optimum route on a display device (not shown), to construct a spatial index for increasing the speed of searching the optimum route, and to construct Contraction Hierarchies, for example. This preprocess is not essential and thus may be omitted.

The routing information storage 27 stores the routing information extracted by the main routing information extractor 4 and the 3D model acquired by the 3D model acquisition module 2.

The required routing information acquisition module 28 acquires, from the information stored in the routing information storage 27, information relating to the search conditions specified by the client device 22.

The route candidate determination module 29 determines an optimum route candidate satisfying the search conditions specified by the client device 22. If information about sunlight importance is included in the search conditions, the route candidate determination module 29 refers to the cost functions stored in the cost function storage 25 to determine an optimum route candidate matching the specified sunlight importance. The optimum route candidate may be determined by using, e.g., a well-known shortest route searching algorithm or an expansion algorithm thereof. Here, the sunlight importance is information showing how much importance is placed on insolation by the user, and is more concretely information about a route having less insolation as much as possible, a route having greater insolation as much as possible, etc. When the user desires a route having less insolation as much as possible, a route having the least insolation between the departure place and the destination is determined as an optimum route candidate. Further, when the user desires a route having greater insolation as much as possible, a route having the greatest insolation between the departure place and the destination is determined as an optimum route candidate.

The user desires a route having less insolation, e.g., when he/she searches a route for walking in the daytime in summer. Further, the user desires a route having greater insolation, e.g., when he/she searches a route for a car having a solar battery panel.

While the route insolation calculator 7, route candidate determination module 29, etc. are performing their processes, the ratio of the shade on each route may possibly change due to the change in the position of the sun. The present embodiment is based on the assumption that the ratio of the shade does not change while the route insolation calculator 7, route candidate determination module 29, etc. are performing their processes.

The client device 22 has a search condition acquisition module 31 and a route candidate imaging module 32. The search condition acquisition module 31 acquires various search conditions inputted by the user. Here, the search conditions include departure time, departure place, destination, sunlight importance, weather conditions, etc. The weather conditions are based on a request from the user concerning temperature, humidity, air temperature, etc.

As stated above, the cost function storage 25 stores information about the insolation of various routes at each certain time, as cost functions. By giving the search conditions acquired by the search condition acquisition module 31 to the cost function storage 25, insolation of an arbitrary route at an arbitrary time can be acquired. Therefore, the route candidate determination module 29 determines an optimum route candidate by acquiring insolation of an applicable route from the cost function storage 25 based on the search conditions transmitted from the client device 22.

For example, when routing information as shown in FIG. 5 is provided, if the search conditions are specified to select a route having less insolation as much as possible between the representative point 1 as the departure point and the representative point 3 as the destination, the route shown with arrows in FIG. 6 is determined as an optimum route candidate.

The route candidate imaging module 32 in the client device 22 performs control for displaying, on a display device (not shown), the optimum route candidate determined by the route candidate determination module 29 in the server device 21. How to display the optimum route is not particularly questioned. For example, a plurality of optimum route candidates may be displayed to make the user select one of them. Further, when displaying a plurality of optimum route candidates, insolation of each candidate may be displayed together.

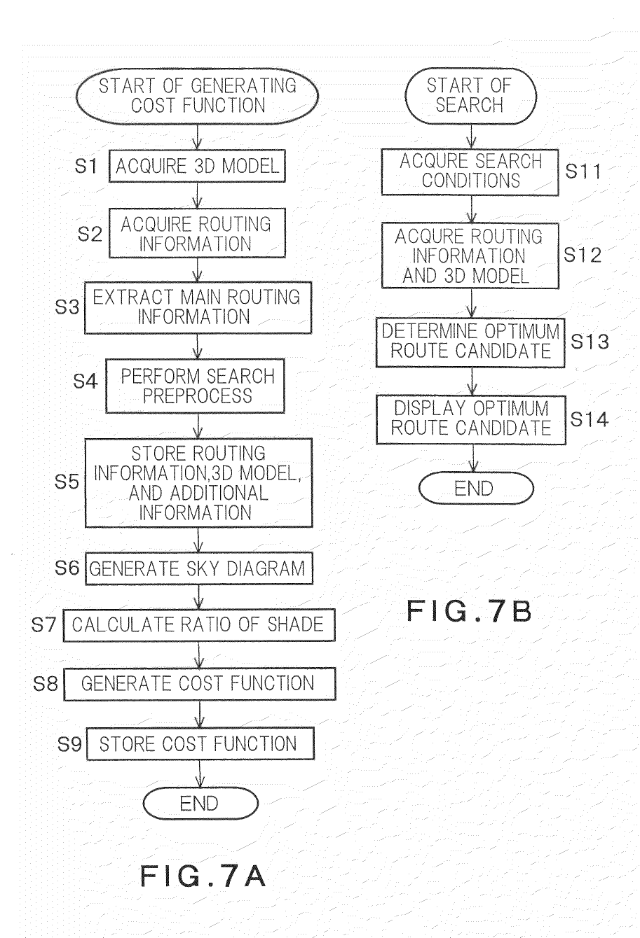

FIG. 7(a) is a flow chart showing an example of the steps performed to generate a cost function.

First, the 3D model acquisition module 2 acquires a 3D model (Step S1), and the routing information acquisition module 3 acquires routing information (Step S2). Next, based on the 3D model and routing information, the main routing information extractor 4 extracts main routing information (Step S3). Next, the search preprocessing module 26 performs a preprocess (Step S4), and stores, in the routing information storage 27, the routing information extracted by the main routing information extractor 4, the 3D model acquired by the 3D model acquisition module 2, and additional information obtained by the preprocess performed by the search preprocessing module 26 (Step S5).

Next, the sky diagram generator 5 generates a sky diagram at each representative point (Step S6). Next, the ratio detector calculates the ratio of the shade on each route connecting two adjacent representative points (Step S7). Next, the cost function synthesizer 30 calculates the insolation of each route at each certain time, and generates a cost function which returns insolation of each route when given time (Step S8). Next, the generated cost function is stored in the cost function storage 25 (Step S9).

FIG. 7(b) is a flow chart showing an example of the steps performed to search an optimum route candidate.

First, the search condition acquisition module 31 acquires search conditions on an optimum route desired by the user (Step S11). Next, the required routing information acquisition module 28 acquires routing information and a 3D model relating to the search conditions (Step S12). Next, the route candidate determination module 29 determines an optimum route candidate satisfying the search conditions (Step S13). Next, the optimum route candidate is displayed on the display device (not shown) of the client device 22 (Step S14).

Note that when utilizing the route proposing device 20 of FIG. 4 simply as the insolation calculating device 1, the route candidate determination module 29 in the server device 21 and the route candidate imaging module 32 in the client device 22 are not necessary.

As stated above, in the second embodiment, insolation of each route is calculated based on the insolation at each representative point and the ratio of the shade on the route connecting adjacent representative points, to store the calculation result in the cost function storage 25 as a cost function. Therefore, when search conditions for calculating insolation are given from the client device 22, the insolation matching these search conditions can be easily acquired from the cost function storage 25, which makes it possible to quickly search a route considering insolation with high accuracy.

### Third Embodiment

A third embodiment to be explained below is different from the second embodiment in the processing operation performed by the cost function synthesizer 30.

The third embodiment is the same as the second embodiment except in the processing operation performed by the cost function synthesizer 30, and the block diagram of the route proposing device 20 is similar to FIG. 4.

The cost function synthesizer 30 according to the second embodiment follows the above rules 1) to 6) depending on whether two adjacent representative points are in the sun or in the shade. With respect to the rule 2), there is a problem of lack of accuracy since when one of two adjacent representative points is in the sun and the other is in the shade, standard insolation in the sun in the area including the representative point in the sun is employed. Accordingly, in the present embodiment, the rule 2) is changed to select a point in the sun on the route connecting two adjacent representative points, generate a sky diagram at this point, calculate insolation based on the generated sky diagram, and to define the calculated insolation as the representative insolation in the sun on this route.

Further, the rule 5) explained in the second embodiment is changed to select a point in the shade on the route connecting two adjacent representative points, generate a sky diagram at this point, calculate insolation based on the generated sky diagram, and to define the calculated insolation as the representative insolation in the shade on this route. The other rules, which are, i.e., rules 1), 3), 4), and 6), are similar to the second embodiment.

In the present embodiment, the component performing the process of providing a new point on a route corresponds to the additional representative point selector 10 in FIG. 1.

Obtaining a cost function following the above rules makes it possible to calculate insolation with higher accuracy compared to the second embodiment using standard insolation.

### Fourth Embodiment

A fourth embodiment to be explained below is different from the second and third embodiments in the processing operation performed by the main routing information extractor 4.

The fourth embodiment is the same as the second and third embodiments except in the processing operation performed by the main routing information extractor 4, and the block diagram of the route proposing device 20 is similar to FIG. 4.

When extracting main routing information from the routing information acquired by the routing information acquisition module 3, the main routing information extractor 4 according to the fourth embodiment divides each route at regular intervals and sets a representative point corresponding to each dividing point, to calculate a sky diagram at the representative point.

Next, the main routing information extractor 4 performs a clustering process for merging sky diagrams which are similar to each other in the calculated sky diagrams into the same cluster. In this process, only characteristic sky diagrams are extracted, and the dividing points corresponding to the sky diagrams are kept as representative points while the other dividing points are eliminated.

In the example explained in FIG. 1, the above process is performed using the subroute generator 11 and cluster classifier 12. This process may be performed by the main routing information extractor 4 as in the present embodiment, or may be performed separately from the main routing information extractor 4 as shown in FIG. 1.

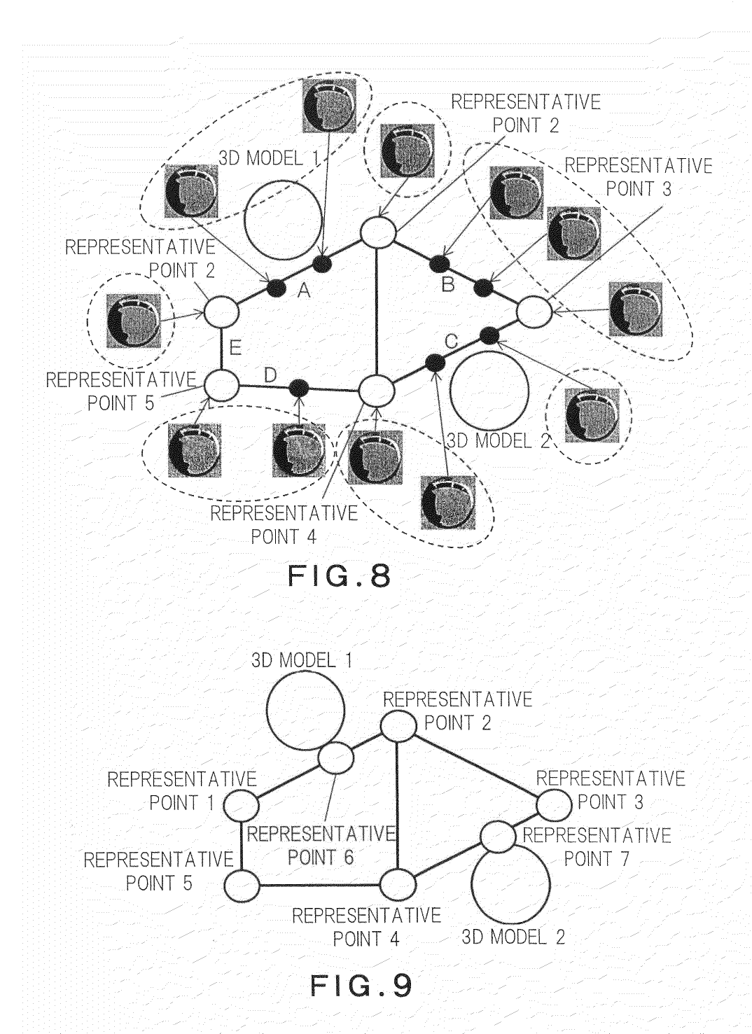

Each of FIGS. 8 and 9 is a diagram showing an example of the clustering process. In FIG. 8, each broken line circle shows a cluster. In FIG. 8, one or more sky diagrams in each cluster are highly similar to each other and thus merged into the same cluster. As shown in FIG. 9, the respective clusters are merged into one representative point. Accordingly, 12 representative points in FIG. 8 are reduced to 7 representative points as shown in FIG. 9.

Such a clustering process produces advantages as explained below. For example, when a huge building is situated near the middle of a straight route connecting intersections in the sun, a large shade appears on the straight route, but the shade of the building does not appear at the intersections at both ends of the route. Thus, in the first to third embodiments, the influence of the building is considered only in terms of the ratio of the shade on the route.

The above clustering process makes it possible to set a new representative point near the building on the route, which means that the influence of the shade of the building can be further considered with higher accuracy when calculating insolation.

As stated above, in the fourth embodiment, the number of representative points can be reduced by dividing each route at predetermined intervals, setting a representative point corresponding to each dividing point to generate a sky diagram at the representative point, and performing a clustering process for merging sky diagrams highly similar to each other in the sky diagrams into one cluster. Since the representative point can be surely set at a spot where insolation changes suddenly, insolation can be calculated with higher accuracy while reducing the number of representative points.

At least a part of the insolation calculating device 1 and route proposing device 20 explained in the above embodiments may be formed of hardware or software. In the case of software, a program realizing at least a partial function of the insolation calculating device 1 and route proposing device 20 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the insolation calculating device 1 and route proposing device 20 can be distributed through a communication line (including radio communication) such as the Internet.

Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An insolation calculating device comprising:
a 3D model acquisition module to acquire a 3D model of an area around a target location to calculate insolation;
a routing information acquisition module to acquire routing information about the area around the location;
a main routing information extractor to acquire main routing information including a plurality of representative points from the routing information acquired by the routing information acquisition module;
a sky diagram generator to generate a sky diagram at each of the representative points, the sky diagram being generated as two-dimensional image data corresponding to a shot image of the whole sky;
a representative point insolation calculator to calculate representative point insolation showing insolation at each of the representative points, based on the sky diagram at the representative point; and
a route insolation calculator to calculate insolation of each route connecting two adjacent representative points in the representative points, based on the representative point insolation at each of the representative points.

2. The insolation calculating device of claim 1, further comprising:
a route representative insolation determination module to calculate representative insolation in the sun and representative insolation in the shade on each route connecting two adjacent representative points in the representative points, based on the representative point insolation at each of the two representative points on the route; and
a ratio detector to detect a ratio of the sun to the shade on each route connecting two adjacent representative points in the representative points,
wherein the route insolation calculator calculates insolation of each route connecting two adjacent representative points in the representative points by weighting the representative insolation in the sun and the representative insolation in the shade corresponding to the route, based on the corresponding ratio.

3. The insolation calculating device of claim 2,
wherein the route representative insolation determination module calculates the representative insolation in the sun and the representative insolation in the shade on the corresponding route, depending on whether both of the two adjacent representative points are in the sun or in the shade, or one is in the sun and the other is in the shade.

4. The insolation calculating device of claim 2, further comprising:
an additional representative point selector to select, when both of two adjacent representative points in the representative points are in the shade, a sunny spot on the route connecting the two representative points, as a new representative point,
wherein the sky diagram generator generates the sky diagram at the new representative point,
the representative point insolation calculator calculates the representative point insolation corresponding to the new representative point, and
the route representative insolation determination module determines the representative point insolation corresponding to the new representative point as the representative insolation in the sun on the route.

5. The insolation calculating device of claim 2, further comprising:
additional representative point selector to select, when both of two adjacent representative points in the representative points are in the sun, a shady spot on the route connecting the two representative points, as a new representative point,
the sky diagram generator generates the sky diagram at the new representative point,
the representative point insolation calculator calculates the representative point insolation corresponding to the new representative point, and
the route representative insolation determination module determines the representative point insolation corresponding to the new representative point as the representative insolation in the shade on the route.

6. The insolation calculating device of claim 1, further comprising:
a subroute generator to generate a plurality of subroutes by dividing each route included in the routing information acquired by the routing information acquisition module at predetermined intervals;
a cluster classifier to collect sky diagrams which are similar to each other in the sky diagrams generated by the sky diagram generator corresponding to dividing points of the subroutes, to merge the collected sky diagrams into one cluster; and
a sky diagram extractor to extract a characteristic sky diagram to calculate the insolation, from the sky diagrams belonging to each cluster classified by the cluster classifier;
wherein the representative point insolation calculator calculates the representative point insolation at a representative point corresponding to the sky diagram extracted by the sky diagram extractor.

7. The insolation calculating device of claim 1,
wherein the representative points are at least partially intersections of a plurality of routes included in the routing information.

8. A route proposing device comprising:
a 3D model acquisition module to acquire a 3D model of an area around a target location to calculate insolation;
a routing information acquisition module to acquire routing information about the area around the location;
a main routing information extractor to acquire main routing information including a plurality of representative points from the routing information acquired by the routing information acquisition module;
a sky diagram generator to generate a two-dimensional sky diagram by imaging the whole sky at each of the representative points;
a ratio detector to detect a ratio of the sun to the shade on each route connecting two adjacent representative points in the representative points;
an insolation pre-calculating module to calculate insolation at each certain time with respect to each route connecting two adjacent representative points in the representative points, by weighting representative insolation in the sun and representative insolation in the shade at the corresponding representative point, based on the corresponding ratio;
an insolation storage to store the insolation calculated by the insolation pre-calculating module while relating the insolation to time;
a search condition acquisition module to acquire a search condition to search a route from a departure place to a destination as specified; and
a route candidate determination module to determine a candidate for an optimum route from the departure place to the destination, by reading the insolation matching the search condition from the insolation storage.

9. The route proposing device of claim 8,
the search condition includes a condition concerning time, a condition concerning insolation, and a condition concerning an area on which route search is performed.

10. An insolation calculating method comprising:
acquiring a 3D model of an area around a target location to calculate insolation;
acquiring routing information about the area around the location;
acquiring main routing information including a plurality of representative points from the acquired routing information;
generating a two-dimensional sky diagram by imaging the whole sky at each of the representative points;
calculating representative point insolation showing insolation at each of the representative points, based on the sky diagram at the representative point; and
calculating insolation of each route connecting two adjacent representative points in the representative points, based on the representative point insolation at each of the representative points.

11. The method of claim 10, further comprising:
calculating representative insolation in the sun and representative insolation in the shade on each route connecting two adjacent representative points in the representative points, based on the representative point insolation at each of the two representative points on the route; and
detecting a ratio of the sun to the shade on each route connecting two adjacent representative points in the representative points,
wherein when calculating insolation of each route connecting two adjacent representative points, insolation of each route connecting two adjacent representative points in the representative points is calculated by weighting the representative insolation in the sun and the representative insolation in the shade corresponding to the route, based on the corresponding ratio.

12. The method of claim 11,
wherein when calculating representative insolation in the sun and representative insolation in the shade on each route, the representative insolation in the sun and the representative insolation in the shade on the corresponding route are calculated depending on whether both of the two adjacent representative points are in the sun or in the shade, or one is in the sun and the other is in the shade.

13. The method of claim 11,
wherein when both of two adjacent representative points in the representative points are in the shade, a sunny spot on the route connecting the two representative points are selected as a new representative point,
the sky diagram is generated at the new representative point,
the representative point insolation corresponding to the new representative point is calculated, and
the representative point insolation corresponding to the new representative point is determined as the representative insolation in the sun on the route.

14. The method of claim 11, further comprising:
wherein when both of two adjacent representative points in the representative points are in the sun, a shady spot on the route connecting the two representative points is selected as a new representative point,
the sky diagram is generated at the new representative point,
the representative point insolation corresponding to the new representative point is calculated, and
the representative point insolation corresponding to the new representative point is determined as the representative insolation in the shade on the route.

15. The method of claim 10, further comprising:
generating a plurality of subroutes by dividing each route included in the routing information acquired by the routing information acquisition module at predetermined intervals;
collecting sky diagrams which are similar to each other in the generated sky diagrams corresponding to dividing points of the subroutes, to merge the collected sky diagrams into one cluster; and
extracting a characteristic sky diagram to calculate the insolation, from the sky diagrams belonging to each cluster;
wherein the representative point insolation at a representative point corresponding to the extracted sky diagram is calculated.

16. The method of claim 10,
wherein the representative points are at least partially intersections of a plurality of routes included in the routing information.
